(19) United States
(12) Patent Application Publication
(10) Pub. No.: US 2017/0230520 A1
(43) Pub. Date: Aug. 10, 2017

(54) Got Them

(71) Applicants: Nataly Y. Montenegro, Glendale, CA (US); Diana C. Garcia, Marina, CA (US)

(72) Inventors: Nataly Y. Montenegro, Glendale, CA (US); Diana C. Garcia, Marina, CA (US)

(21) Appl. No.: 15/041,025

(22) Filed: Feb. 10, 2016

(51) Int. Cl. H04N 1/00; G06T 11/60; G06F 17/30; H04N 5/232

(52) U.S. Cl. CPC H04N 1/00209; H04N 1/00244; H04N 5/23229; G06T 11/60; G06F 17/30268; H04N 2201/0084; H04L 51/08

(57) ABSTRACT

The system is configured to provide a mobile and web application for sharing the pictures and videos with the tagged persons. Also, an image sharing method comprising the steps of logging into a portable device by a plurality of interfaces, creating a plurality of images by the portable device, tagging the plurality of images for the plurality of tagged persons, searching for the plurality of tagged persons in a database by a means for data communication, shuttering the plurality of images with the plurality of tagged persons, recognizing a plurality of tagging of the plurality of images by the plurality of tagged persons, sharing a plurality of images with the plurality of tagged persons and receiving of the plurality of images by the plurality of tagged persons. Further, the plurality of portable devices is selected from a group of digital communication devices comprising laptop, smartphone and tablet.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of the Invention

This invention relates to the field of an image sharing system and method thereof and in particularly, to tagging, processing and organizing photographs and videos taken by a portable device.

(2) Background of the Invention

Modern-day handheld communication devices are capable of performing a multitude of tasks such as voice communication, playing music, listen to radio, watching live broadcast television, browsing the Internet, playing games, working with documents, and taking photographs.

The number of mobile communication devices having integrated cameras has more or less exploded in the last couple of years. Nowadays almost every mobile communication device has been fitted with a camera module capable of taking high resolution pictures of good quality. This, together with the development in, and price reduction of, high capacity memories have resulted in that users are taking photographs of people and objects on a more or less daily basis, often resulting in large volumes of photographs.

Users of mobile devices with camera capabilities, referred to herein as mobile camera devices, utilize their mobile camera devices to capture and store images. These users, also referred to herein as photographers, often then desire to share one or more of their captured images with one or more other people, a website or web location and/or other user devices, e.g., the photographer's home-based computer, etc. Camera-equipped cell phones have facilitated news gathering and event reporting, intimate personal communications, in which pictures and images can elicit a wider range of emotional responses than voice signals alone, and business-related and research-related information transfer. However, currently, it is difficult for users to transfer their digital pictures from camera-equipped cell phones to personal computers or to other locations. Users, retailers, and designers of both computer systems and camera-equipped cell phones have recognized the need for easier, more intuitive, and more robust methods for transferring digital images recorded on camera-equipped cell phones to computers, including personal computers and workstations.

Various prior arts have disclosed system and method for such media transfers. Patent No US 20140030980 A1 discloses a system and method for a first user to share user content from a first mobile device with a second user of a second mobile device, including inviting, by the first mobile device, the second mobile device to communicate with first mobile device. US 20120086792 A1 discloses system and method to analyze a captured image that is automatically processed to attempt to identify persons portrayed therein.

Patent No US 20120324002 A1 discloses a method for a server to provide a media sharing service that includes creating an event tag for sharing media with members of an event and receiving, from a first user on a first on a first client device, a request to tag one or more media files with the event tag. US 20140047016 A1 discloses a server infrastructure and a mobile client device with a mobile app that facilitates mobile blogging and controlled sharing of blog entries. Another prior art, U.S. Pat. No. 9,009,265 B2 discloses a system and method which allows for the transfer of data captured by one device to be processed and moved to another location in accordance with pre-established criteria without requiring user interaction at the time of data capture.

Thus, it is desirable to utilize the computational and communicative power of a user's mobile camera device to assist a user to efficiently identify recipients for a captured image and quickly, with minimal user effort, share the captured image with the identified recipients.

### SUMMARY

In view of the foregoing disadvantages inherent in the known types of application software for sharing of media files from one device to another or like in the prior art, the present invention provides an improved mobile application software for such sharing at a single point of time while clicking pictures and reducing the hassle caused in transferring of such pictures later. As such, the general purpose of the present invention, which will be described subsequently in greater detail, is to provide a new and improved mobile application software for data sharing and transfer, with all the advantages of the prior art and none of the disadvantages.

It is an object of the present invention to provide an image sharing system and method thereof. The system is configured to provide a mobile and web application for sharing the pictures and videos with the tagged persons.

A further object of the present invention is to provide an image sharing method comprising the steps of logging into a portable device by a plurality of interfaces, creating a plurality of images by the portable device, tagging the plurality of images for the plurality of tagged persons, searching for the plurality of tagged persons in a database by a means for data communication, shuttering the plurality of images with the plurality of tagged persons, recognizing a plurality of tagging of the plurality of images by the plurality of tagged persons, sharing a plurality of images with the plurality of tagged persons and receiving of the plurality of images by the plurality of tagged persons. Further, the plurality of portable devices is selected from a group of digital communication devices comprising laptop, smartphone and tablet.

A further object of the present invention is to provide improved mobile application software with necessary features of sharing and transferring the plurality of images and videos at a single point of time from a first user to tagged user/s.

A further object of the present invention is to provide improved mobile application that shares the image captured simultaneously at different mobile device users provided the respective users are tagged prior to the image capture.

Particular embodiments relate to methods of automatically capturing the image by selecting one or more frames from a real-time video sequence based on social network information and identity recognition.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE SEVERAL VIEWS OF THE DRAWINGS

FIG. 1 illustrates an image sharing system and method thereof, in accordance with an embodiment of the present invention.

### DETAILED DESCRIPTION OF THE INVENTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

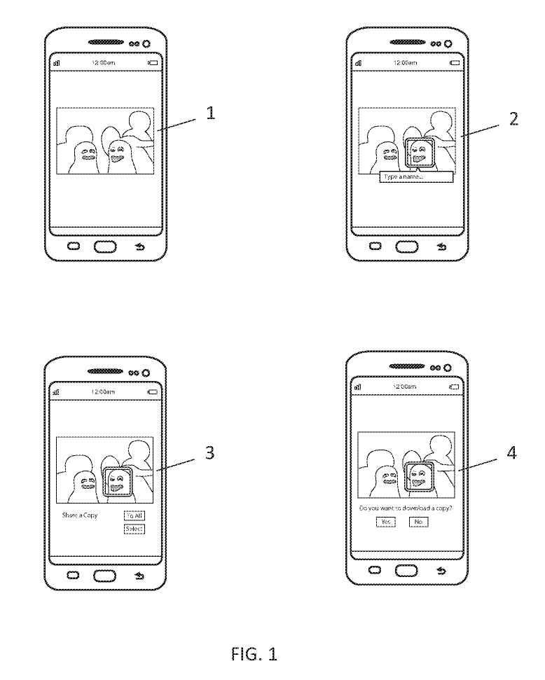

In accordance with an embodiment of the present invention shown in FIG. 1, an image sharing method comprising the steps of logging into a portable device (1) by a plurality of interfaces, creating a plurality of images (2) by the portable device, tagging the plurality of images (3) for the plurality of tagged persons, searching for the plurality of tagged persons in a database by a means for data communication, shuttering the plurality of images with the plurality of tagged persons, recognizing a plurality of tagging of the plurality of images by the plurality of tagged persons, sharing a plurality of images (4) with the plurality of tagged persons and receiving of the plurality of images by the plurality of tagged persons (5). Further, the plurality of portable devices is selected from a group of digital communication devices comprising laptop, smartphone and tablet.

In some preferred embodiments, the present invention provides mobile application software for sharing and transferring captured images at single point of time between multiple tagged users.

This section summarizes some aspects of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

Embodiments discussed herein includes systems and methodology for processing captured images and sharing captured images to one or more tagged users over a communication network e.g. over mobile network etc.

The present invention is directed to a system and method which allows for the transfer of data captured by one device to be processed and moved to another location in accordance with the pre-established criteria without requiring user interaction at the time of data capture. In one embodiment, images from a camera-equipped phone are shared to other mobile device tagged users through a file server in accordance with the pre-established guidelines. The camera-equipped phone generates a digital image, for example by taking a digital photo with a built-in or attached camera, and transmits the digital image over a standard wireless network, for example the cellular GSM/GPRS network, to a file server. The file server receives the digital data from the camera-equipped phone and forwards the data to a pre-identified location, such as other mobile device user's (or to an image processing facility) through the Internet.

In one embodiment, the incoming data to the other mobile device users is directed to specific applications as opposed to simply storing the data in a storage location. In other embodiments, the intermediate server interprets the data and redirects both the location to which the data is delivered as well as the function to be performed on the data at the redirected location.

Upon installation of the phone, the image transfer phone software is generally configured with the address of the fileserver, plus any additional configuration parameters necessary for the image-transfer phone software to operate. The image transfer phone software may be automatically started when the user open the camera feature on his phone. After turning the camera feature on, the user can generate an image, for example by taking a picture with the camera-equipped phone.

In an embodiment, while the user gets ready to click the image, other users can be pre-tagged in the image by allowing the disclosed mobile application software to access the camera feature, and the clicked image can be shared with the pre-tagged users at the same point of time. Accordingly, the present invention allows the user to share captured and stored images from one device to another by “tagging” people who are in the image prior taking the image. This will allow the user to reduce the hassle created while sharing the pictures with multiple users.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I/We claim:

1. An image sharing method comprising the steps of:
logging into a portable device by a plurality of interfaces;
creating a plurality of images by said portable device;
tagging said plurality of images for said plurality of tagged persons;
searching for said plurality of tagged persons in a database by a means for data communication;
shuttering said plurality of images with said plurality of tagged persons;
recognizing a plurality of tagging of said plurality of images by said plurality of tagged persons;
sharing a plurality of images with said plurality of tagged persons; and
receiving of said plurality of images by said plurality of tagged persons.

2. The image sharing method according to claim 1, wherein said step of creating further comprising the step of collaging of said plurality of images by said portable device.

3. The image sharing method according to claim 2, wherein said step of collaging is performed by a means of collaging.

4. The image sharing method according to claim 3, wherein said means of collaging is configured to provide with said plurality of interfaces.

5. The image sharing method according to claim 1, wherein said step of tagging further comprising the step of swapping said plurality of images for editing said plurality of tagged persons.

6. The image sharing method according to claim 1, wherein said step of shuttering is performed by a shutter button available on said portable device.

7. The image sharing method according to claim 1, wherein said plurality of images is selected from a plurality of photos and videos.

8. The image sharing method according to claim 1, wherein said means for data communication is a wireless communication network.

9. An image sharing system, comprising;
a plurality of portable devices is configured to logging in a plurality of interfaces;
means for creating and editing a plurality of images stored in said plurality of portable devices
means for tagging said plurality of images for a plurality of tagged persons by a plurality of users;
means for data communication for sending said plurality of images to said plurality of tagged persons; and
means for storing said plurality of images on a memory of said plurality of portable devices.

10. The system according to claim 1, wherein said means for creating and editing a plurality of images are a camera device.

11. The system according to claim 1, wherein said means for tagging said plurality of images is performed by a processor.

12. The system according to claim 1, wherein said means for data communication is a wireless network.

13. The system according to claim 1, wherein said plurality of images is shared with said plurality of tagged persons by a shutter button.

14. The system according to claim 1, wherein said plurality of tagged persons is managed by a swapping mechanism available on said plurality of interfaces.

15. The system according to claim 1, wherein said plurality of interfaces is configured to connect to a web application.

16. The system according to claim 1, wherein said plurality of portable devices is selected from a group of digital communication devices comprising laptop, smartphone and tablet.
